(19) United States
(12) Patent Application Publication
(10) Pub. No.: US 2003/0234610 A1
(43) Pub. Date: Dec. 25, 2003

(54) Control of leachable mercury in small diameter fluorescent lamps

(76) Inventors: Keith A. Klinedinst, Hudson, MA (US); Dennis B. Shinn, Topsfield, MA (US)

Correspondence Address: William H. McNeill, OSRAM SYLVANIA Inc., 100 Endicott Street, Danvers, MA, 01923, US

(21) Appl. No.: 10/174,912

(22) Filed: Jun. 19, 2002

(51) Int. Cl. H01J 17/26

(52) U.S. Cl. 313/565

(57) ABSTRACT

A method for inhibiting the leaching of mercury from a mercury vapor discharge lamp having a diameter of less than 1.5 inches wherein at least a part of the mercury is present as ionic mercury includes depositing a coating of SnO₂ on an interior surface of the lamp envelope. Further included within the lamp is a quantity of oxidizable iron in an amount equal to at least 1 gram per kilogram of lamp weight.

### TECHNICAL FIELD

This invention relates to mercury vapor discharge lamps and more particularly to fluorescent lamps. Still more particularly it relates to lamps that can be landfilled without leaching potentially damaging mercury into the environment.

### BACKGROUND ART

Fluorescent lamps contain elemental mercury. During lamp operation, chemical reactions take place that convert some of the elemental mercury to salts or compounds, such as mercuric oxide (HgO), that are water soluble. There is a growing concern that a waste stream resulting from the disposal of fluorescent lamps may leach excessive amounts of this soluble form of mercury (Hg) into the environment. An acceptable method of measuring the amount of soluble mercury which may leach from the waste stream resulting from the disposal of fluorescent lamps is described in the Toxicity Characteristic Leaching Procedure (TCLP) prescribed on pages 26987-26998 of volume 55, number 126 of the Jun. 29, 1990 issue of the Federal Register. The lamp to be tested is pulverized into granules having a surface area per gram of materials equal to or greater than 3.1 cm² or having a particle size smaller than 1 cm in its narrowest dimension. The granules are then subject to a sodium acetate buffer solution having a pH of approximately 4.9 and a weight twenty times that of the granules. The buffer solution is then extracted, and the concentration of mercury is measured. At the present time, the United States Environmental Protection Agency (EPA) defines a maximum concentration level for mercury to be 0.2 milligram of leachable mercury per liter of leachate fluid when the TCLP is applied. According to the present standards, a fluorescent lamp is considered nonhazardous (and thus available to be conventionally land-filed) when less than 0.2 milligram per liter of leachable mercury results using the TCLP. Lamps that have leachable mercury concentrations above the allowable limit must be especially disposed of through licensed disposal operations. Disposal operators charge a fee for disposal of lamps that are not within the EPA's limits. Therefore, customers must pay extra costs to dispose of these lamps. Customers of fluorescent lamps generally desire not to contend with disposal issues regarding mercury levels, and therefore some customers specify only those lamps which pass the TCLP standard.

Heretofore, efforts have been made to reduce the leaching of soluble mercury from fluorescent lamps during the TCLP testing as well as in landfills. Various methods have been proposed which attempt to treat or process burned-out discharge lamps or scrap lamp exhaust tubing containing mercury in order to reclaim the mercury and thereby reduce the amount of mercury-contaminated scrap.

U.S. Pat. No. 5,998,927, Foust, et al., teaches a method for in g the formation of leachable mercury associated with a mercury arc vapor discharge lamp when the mercury is in elemental form The method comprises providing high-iron content metal components in the lamps, at least one of the high-iron content metal components having an amount of oxidizable iron of at least about 1 gm per kilogram of lamp weight.

What is not specifically addressed in the patent, however, is the situation in which practically all of the mercury may already be present in the soluble ionic form at the start of the TCLP testing, as a result of naturally occurring processes that take place within the fluorescent lamp during its operation.

U.S. patent application Ser. No. 10/ , , (Attorney Docket No. 02-1-803) filed concurrently herewith, the teachings of which are hereby incorporated by reference, discloses large diameter fluorescent lamps (e.g., T12) with reduced mercury leaching occasioned by the application within the lamp of a non-conductive tin oxide layer working in conjunction with an amount of oxidizable iron.

It would be an advance in the art if mercury leaching from small diameter fluorescent lamps (e.g., those with diameters less than 1 inch) could be achieved.

### DISCLOSURE OF INVENTION

It is, therefore, an object of the invention to obviate the disadvantages of the prior art.

It is another object of the invention to enhance the disposal of fluorescent lamps.

It is yet another object of the invention to allow conventional landfill disposal of fluorescent lamps of all diameters when the mercury contained therein is in the ionic form.

### BEST MODE FOR CARRYING OUT THE INVENTION

For a better understanding of the present invention, together with other and further objects, advantages and capabilities thereof, reference is made to the following disclosure and appended claims.

As disclosed in the afore-mentioned co-pending application, it has been discovered that replacing the electrically conductive tin oxide coating of T12 fluorescent lamps with a non-electrically conductive tin oxide coating in conjunction with an amount of oxidizable iron will reduce the mount of leachable mercury in said lamps when that mercury is present in its ionic form.

It has now been discovered that applying a coating of tin oxide to envelopes having diameters less than 1.5 inches is equally efficacious in preventing the leaching of mercury from mercury-containing fluorescent lamps, as determined by TCLP, and this condition applies whether the tin oxide is conducting or non-conducting.

### EXAMPLE I

Four TCLP tests were run, in each case using the components of standard T8 fluorescent lamps having tubular glass envelopes 4 feet long. Two additional tests were run with similar components, except that the inside surface of the tubular glass envelopes was coated with a tin oxide having the same thickness and composition as that normally used as a starting aid with T12 lamps, i.e., a density of about 40 micrograms/cm². Also included in each test was a SAES mercury dispenser/getter strip 2.5 cm² in area, a piece of metallic iron foil 0.15 mm thick and either 1.6 cm² or 2.5 cm² in area, and 4.5 mg of ionic mercury (as HgO). The results are shown in Table I.

TABLE I
TCLP Results for T8 Lamps having 4.5 mg of Soluble Ionic Mercury

| | Fe Foil | Final Soluble Hg | Final Soluble Fe |
|---|---|---|---|
| SnO₂Coating | (cm²) | Concentration (mg/l) | Concentration (mg/l) |
| Yes | 1.6 | 0.14 | 11 |
| Yes | 1.6 | 0.15 | 11 |
| No | 1.6 | 0.19 | 6.7 |
| No | 1.6 | 0.20 | 7.2 |
| No | 2.5 | 0.20 | 12 |
| No | 2.5 | 0.21 | 14 |

As shown by the results in Table I, extracted mercury concentrations well below the critical 0.2 mg/l value are obtained when SnO₂-coated glass was combined with only 1.6 cm² of metallic iron foil, whereas failing or nearly failing results were obtained when the standard uncoated glass tubing was used with either 1.6 or 2.5 cm² of iron foil (Note that 1.6 cm² of 0.15 mm thick iron foil is equivalent to approximately 1.5 grams of metallic iron per kilogram of lamp weight).

### EXAMPLE II

Six additional TCLP tests were run, in each case using the components of a standard T5 fluorescent lamp with a glass envelope 45 inches long. In three of the six tests the inside surface of the tubular glass was coated with tin oxide having the same thickness and composition as that employed in Example I. Also included in each test was a quantity of ionic mercury (2 or 4 mg, as HgO) and a quantity of metallic iron foil (0.75 or 1.5 cm² in area and 0.15 mm thick). Most tests also included a SAES mercury dispenser/getter strip 0.75 cm² in area. The conditions of each test and the corresponding results are summarized in Table II.

TABLE II
TCLP Results for T5 Lamps with 2 or 4 mg of Soluble Ionic Mercury

| | | | | Final | Final |
|---|---|---|---|---|---|
| | | | | Soluble Hg | Soluble Fe |
| SnO₂ | Ionic Hg | Fe Foil | SAES | Concn. | Concn. |
| Coating | (as HgO, mg) | (cm²) | Getter | (mg/l) | (mg/l) |
| No | 2 | 0.75 | Yes | 0.20 | 9 |
| Yes | 2 | 0.75 | Yes | 0.14 | 10 |
| No | 4 | 0.75 | Yes | 0.37 | 5 |
| Yes | 4 | 0.75 | Yes | 0.14 | 8 |
| No | 4 | 1.5 | No | 0.21 | 11 |
| Yes | 4 | 1.5 | No | 0.14 | 13 |

With both quantities of ionic mercury, the extracted mercury concentrations were well below the critical 0.2 mg/l value when the SnO₂-coated glass was combined with only 0.75 cm² of metallic iron foil, whereas failing results were obtained when the standard uncoated glass was used, regardless of the amount of iron foil and regardless of the amount of ionic mercury.

This method for controlling the amount of leachable mercury in fluorescent lamps with diameters less than 1.5 inches is based upon the surprising synergy that exists between SnO₂ deposited upon the inside surface of the glass envelope and a relatively small amount of oxidizable iron or other high iron content metal contained with the lamp. The high iron content metal can be included within the lamp in a variety of ways, as is known.

While a number of attempts have been made to determine experimentally the mechanism responsible for the surprising synergy between SnO₂ and oxidizable metallic iron, no completely satisfactory explanation has emerged. Nevertheless, the following hypothetical explanation is offered which is at least consistent with all of the known facts:

Step 1) Metallic iron oxidizes and dissolves in the acidic extraction fluid as Fe²⁺.

Step 2) The dissolved ferrous iron adsorbs upon the surface of the SnO₂-coated glass.

Step 3) Dissolved ionic mercury ions also adsorb upon the SnO₂-coated glass surface.

Step 4) The adsorbed ferrous iron and mercury ions interact on the surface of the SnO₂-coated glass to effect the oxidation of the ferrous iron (to Fe³⁺) with the corresponding reduction of ionic mercury to the essentially insoluble elemental form.

While there have been shown and described what are at present considered to be the preferred embodiments of the invention, it will be apparent to those skilled in the art that various changes and modification can be made herein without departing from the scope of the invention as defined by the appended claims.

What is claimed is:

1. In a method for inhibiting leaching of mercury from a mercury vapor discharge lamp wherein at least a part of said mercury is present as ionic mercury the steps comprising:
providing an envelope having a diameter less than 1.5 inches;
depositing upon an interior surface of said envelope a coating of SnO₂; and
including within said lamp oxidizable iron in an amount of at least 1 gram per kilogram of lamp weight.

2. The method of claim 1 wherein said diameter of said envelope is 1 inch.

3. The method of claim 1 wherein said diameter of said envelope is 0.625 inch.

4. The method of claim 1 wherein said mercury is present as mercury oxide.

5. The method of claim 1 wherein said coating of SnO₂ has a density of about 40 micrograms/cm².

6. In a arc discharge lamp having an envelope with a diameter of less than 1.5 inches and including ionic mercury and at least one component comprised of oxidizable iron in an amount of at least 1 gram per kilogram of lamp weight, the improvement comprising:
a coating of SnO₂ deposited on an interior surface of said envelope, said coating of SnO₂ being in an amount sufficient to limit the concentration of leachable mercury to less than 0.2 mg/l of soluble mercury when said lamp is pulverized and treated with a sodium acetate solution having a weight 20 times that of the pulverized lamp components and a pH of about 4.9.

7. The lamp of claim 6 wherein said diameter of said envelope is 1 inch.

8. The lamp of claim 6 wherein said diameter of said lamp is 0.625 inch.

9. The Lamp of claim 6 wherein said ionic mercury is present as mercury oxide.

10. The lamp of claim 6 wherein said coating of SnO₂ has a density of about 40 micrograms/cm².
